(19) United States
(12) Patent Application Publication
(10) Pub. No.: US 2020/0216300 A1
(43) Pub. Date: Jul. 9, 2020

(54) CARTS FOR LIFTING PALLETS

(71) Applicant: Cannon Equipment LLC, Cannon Falls, MN (US)

(72) Inventors: Clemance Bernard Finstad, Bay City, WI (US); Keith Jackson, Minneapolis, MN (US)

(73) Assignee: Cannon Equipment LLC, Cannon Falls, MN (US)

(21) Appl. No.: 16/297,155

(22) Filed: Mar. 8, 2019

Related U.S. Application Data
(60) Provisional application No. 62/790,115, filed on Jan. 9, 2019.

(51) Int. Cl. B66F 9/20

(52) U.S. Cl. CPC B66F 9/20

(57) ABSTRACT

In certain examples, a cart is for lifting a load and the cart has a base frame, a lifting frame pivotally coupled to the base frame with a link arm, a handle pivotally coupled to the base frame at a first pivot axis, and a brace. The brace has a first end pivotally coupled to the handle at a second pivot axis that is spaced apart from the first pivot axis along the handle and an opposite second end pivotally coupled to the lifting frame at a third pivot axis that is between the link arm and the first pivot axis along the lifting frame to thereby achieve a mechanical advantage for pivoting the lifting frame relative to the base frame as the handle is pivoted about the first pivot axis.

### CROSS-REFERENCE TO RELATED APPLICATION

The present disclosure is based on and claims priority to U.S. Provisional Patent Application No. 62/790,115, filed Jan. 9, 2019, the disclosure of which is incorporated herein by reference.

### FIELD

The present disclosure relates to carts and specifically to carts for lifting pallets.

### BACKGROUND

The following U.S. Patent and Publication are incorporated herein by reference in entirety.

U.S. Patent Application No. 2015/0225215 discloses a pallet lift having a base and a plurality of wheels supporting the base. A pair of contact surfaces are proximate a distal end of the base. A handle projects upward proximate a proximal end of the base. A rear support surface support is on the base between the contact surfaces and the handle. The base may include a pair of spaced apart rails capable of receiving columns of a pallet therebetween. In one embodiment, the base includes a pair of four-bar linkages and the handle is a lift handle configured to selectively collapse and extend the four-bar linkages to raise and lower a pallet.

U.S. Pat. No. 10,137,838 discloses a cart apparatus for moving objects. The cart apparatus includes a frame that defines a cavity and steps operably coupled to the frame. The steps are movable into and between an inoperable position in which the steps are nested in the cavity and an operable position in which the steps are at least partially outside the cavity. One of the steps and the frame has a guide pin, and the other of the steps and the frame defines a slot in which the guide pin is slidably received. The slot is configured to guide the steps into and between the inoperable position and the operable position as the guide pin slides in the slot.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a cart is for lifting a load and the cart has a base frame, a lifting frame pivotally coupled to the base frame with a link arm, a handle pivotally coupled to the base frame at a first pivot axis, and a brace. The brace has a first end pivotally coupled to the handle at a second pivot axis that is spaced apart from the first pivot axis along the handle and an opposite second end pivotally coupled to the lifting frame at a third pivot axis that is between the link arm and the first pivot axis along the lifting frame to thereby achieve a mechanical advantage for pivoting the lifting frame relative to the base frame as the handle is pivoted about the first pivot axis.

In certain examples, a cart is for lifting a load and the cart has a base frame, a lifting frame pivotally coupled to the base frame with a link arm and having a pivot pin, a handle pivotally coupled to the base frame, and a brace pivotally coupled to the handle and having a slot with an end. The pivot pin is slidably received into the slot to thereby couple the brace to the lifting frame. The handle is pivotable into and between a folded position in which the handle is folded onto the lifting frame and a lifting position in which the handle is transverse to the base frame and the lifting frame is pivoted away from the base frame. As the handle is pivoted from the folded position toward the lifting position the slot slides along the pivot pin until the pivot pin contacts the end of the slot such that continued pivoting of the handle toward the lifting position causes the handle to apply a force to the lifting frame via the brace to thereby pivot the lifting frame away from the base frame.

In certain examples, a cart is for lifting a load, and the cart has a base frame, a handle bracket on the base frame and defining a notch, a lifting frame pivotally coupled to the base frame, a handle pivotally coupled to the handle bracket, and a brace having a first end pivotally coupled to the handle and an opposite second end pivotally coupled to the lifting frame. The handle is pivotable into and between a folded position in which the handle is folded onto the lifting frame and a lifting position in which the handle is transverse to the base frame and the lifting frame is pivoted away from the base frame. When the handle is in the lifting position a latch pin is received into the notch of the handle bracket to thereby lock the handle in the lifting position.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example cart according to the present disclosure.

FIG. 2 is an exploded view of the cart shown in FIG. 1.

FIG. 3 is an exploded view of a handle apparatus within line 3-3 shown in FIG. 2.

FIG. 4 is an enlarged view of an end of a handle bracket within line 4-4 shown in FIG. 2.

FIG. 5 is a partial view of the handle apparatus with a latch handle in an inactive position.

FIG. 6 is a view like FIG. 5 with the latch handle in an active position.

FIG. 7 is a perspective view of the cart of FIG. 1 with the handle apparatus in a folded position.

FIG. 8 is a perspective view of the cart of FIG. 1 with the handle apparatus in a lifting position.

FIG. 9 is view like FIG. 8 with a pallet being lifted.

FIG. 10 is a side view of the cart of FIG. 1 with the handle apparatus in an intermediate position (shown in solid lines) and the lifting position (shown in dashed lines).

FIG. 11 is an enlarged view of a locking device for locking the cart in the folded position.

### DETAILED DESCRIPTION

Pallets are typically used to support goods during storage and shipment to and from various locations such as warehouses and retail stores. During research and development, the present inventors conceived of the presently disclosed carts that enable an operator to easily lift and move a pallet loaded with heavy goods.

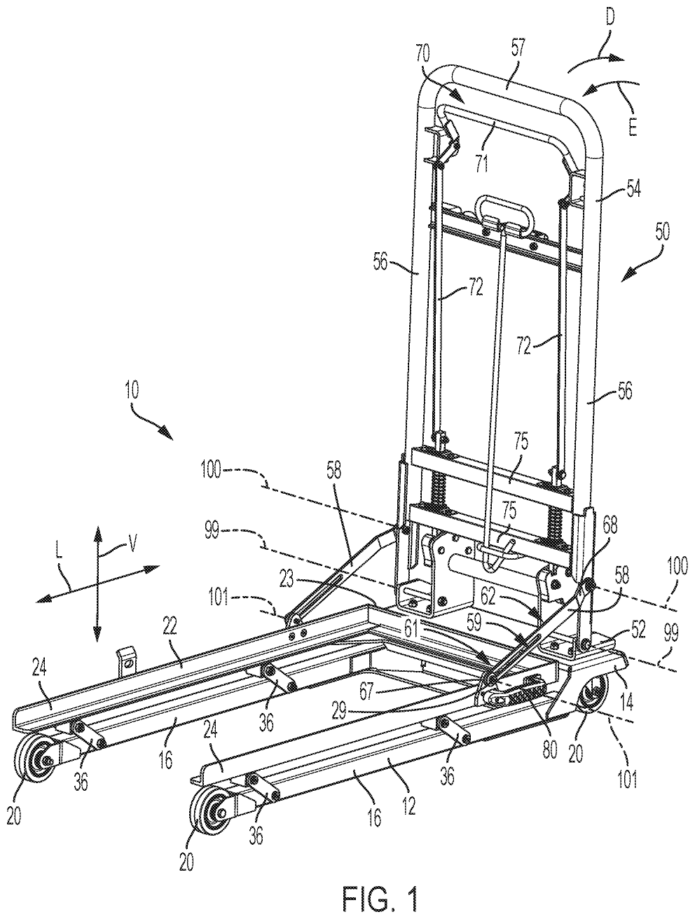

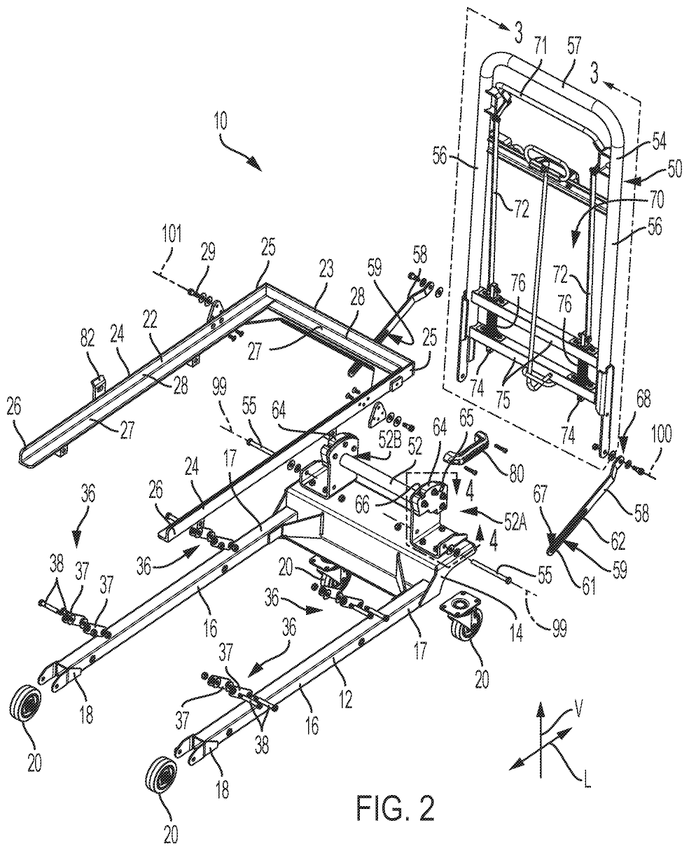

FIGS. 1-2 depict an example cart 10 of the present disclosure. The cart 10 has a base frame 12, a lifting frame 22 vertically above the base frame 12, and a handle apparatus 50 having a handle 54 that is pivotable relative to the base frame 12 to thereby pivot and move the lifting frame 22 relative to the base frame 12.

The base frame 12 has a body 14 and a pair of base arms 16 that are parallel to each other and longitudinally extend from the body 14. Each base arm 16 has a first end 17 coupled to the body 14 and an opposite distal second end 18. The lifting frame 22 has a cross member 23 extending above the body 14 and a pair of lifting arms 24 that longitudinally extend away from the cross member 23 above the base arms 16. Each lifting arm 24 has a first end 25 coupled to the cross member 23 and an opposite distal second end 26. The lifting arms 24 and the cross member 23 are “L”-shaped members, each having a longitudinal lifting surface 27 and a side surface 28 that perpendicularly extends relative to the longitudinal lifting surface 27 (see longitudinal arrow L and vertical arrow V). The base frame 12 and lifting frame 22 are supported above the ground by a set of wheels 20 on the base frame 12.

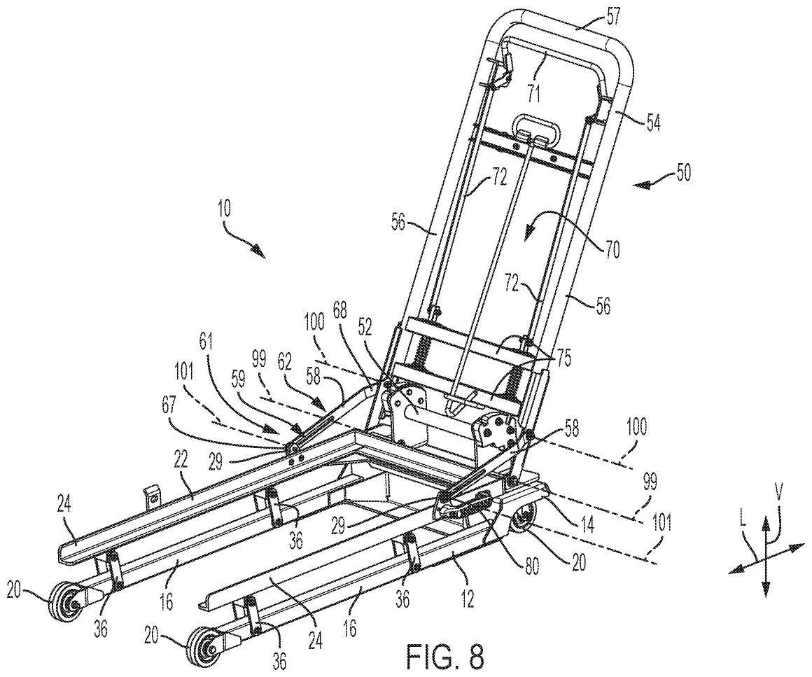

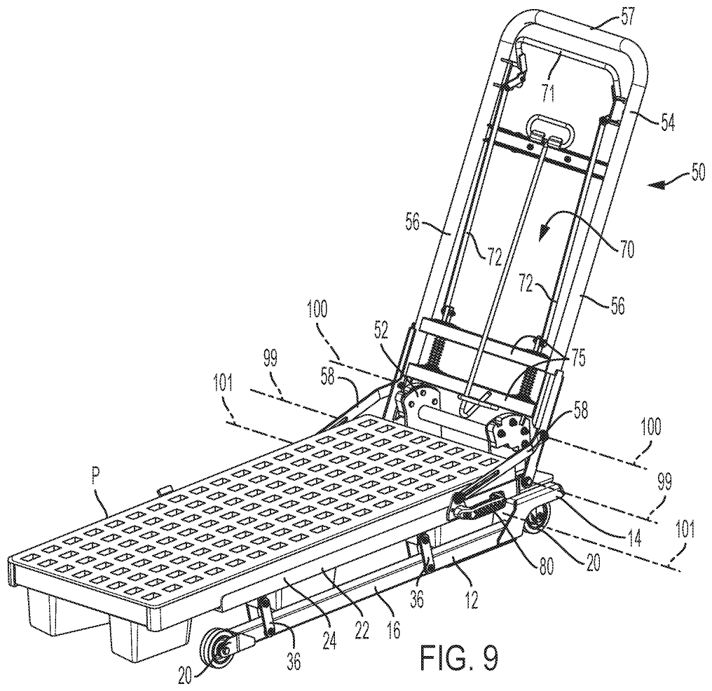

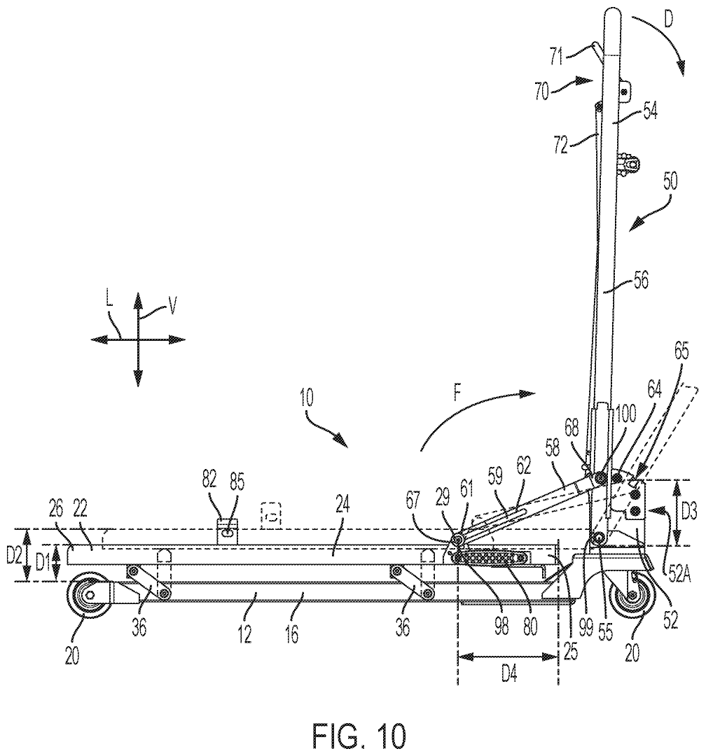

One or more link assemblies 36 pivotably couple the lifting frame 22 to the base frame 12 so that as the handle 54 pivots relative to the base frame 12 the lifting frame 22 is pivoted vertically up and down with respect to the base frame 12 into and between a lowered position (FIGS. 1 and 10) and a raised position (FIGS. 8 and 9) to thereby lift a pallet P (see FIG. 9) off the ground and set the pallet P back down on the ground (described further hereinbelow). The type and configuration of the link assemblies 36 can vary from what is shown. In the illustrated example (referring specifically to FIG. 2), each link assembly 36 includes a pair of link arms 37 that are pivotally coupled to the base arm 16 and the lifting arm 24. Each link arm 37 is positioned alongside the base arm 16 and the lifting arm 24, and each link arm 37 is secured to the cart 10 by fasteners 38. In the illustrated example, two link assemblies 36 connect each base arm 16 to the respective lifting arm 24. The exact location of the link assemblies 36 can vary from what is shown.

As noted above, the handle 54 is for pivoting and moving the lifting frame 22 relative to the base frame 12. Specifically, the handle 54 is coupled to a stationary handle bracket 52 on the body 14 of the base frame 12. The handle bracket 52 has a first end 52A, an opposite second end 52B, and an outer bearing surface 64 at each end 52A, 52B (FIG. 2). First and second notches 65, 66 are formed in the outer bearing surface 64. The handle 54 is pivotally coupled to each end 52A, 52B of the handle bracket 52 with pins 55. The pins 55 define a first pivot axis 99 (see also FIG. 8). In the illustrated example, the handle 54 is “U”-shaped with a pair of parallel legs 56 and a crossbar 57 extending between the legs 56.

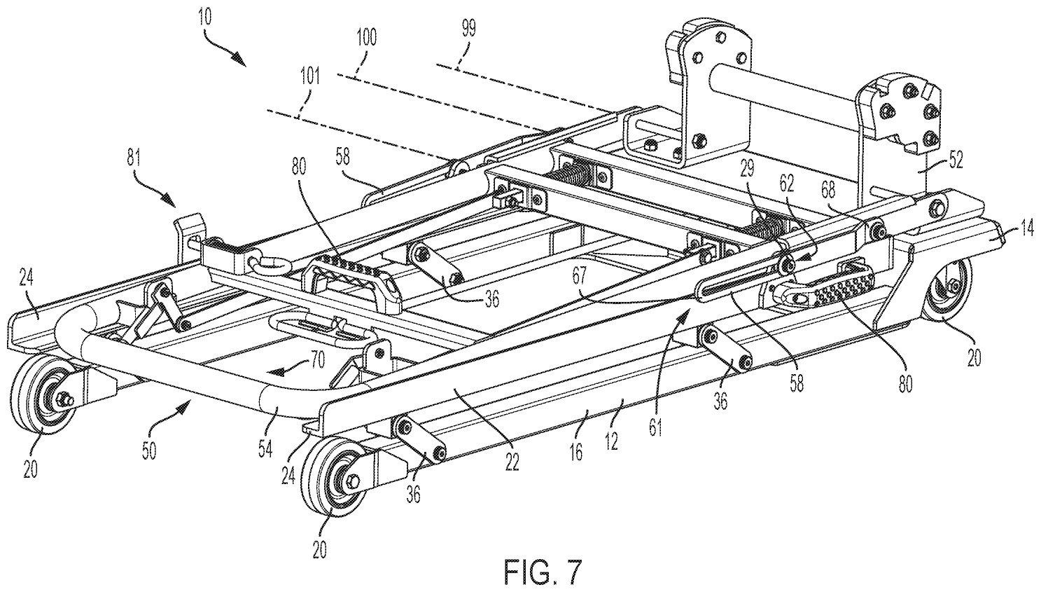

The handle 54 is coupled to the lifting frame 22 with braces 58. Specifically, each brace 58 is pivotally coupled to the legs 56 of the handle 54 at a second pivot axis 100 (see also FIG. 8) and to pivot pins 29 on the lifting arms 24 at a third pivot axis 101. Each brace 58 has a first end 67 at one of the lifting arms 24 and an opposite second end 68 at one of the legs 56 of the handle 54 (FIG. 2). Each brace 58 also has a slot 59 in which one of the pivot pins 29 slides as the handle 54 is pivoted into and between a folded position (FIG. 7) and an intermediate position (FIG. 1), and/or a lifting position (FIG. 8) (note that each position is described in greater detail hereinbelow). The slot 59 extends between the ends 67, 68 of the brace 58, and the slot 59 has a first slot end 61 positioned near the first end 67 of the brace 58 and an opposite second slot end 62 positioned near the second end 68 of the brace 58.

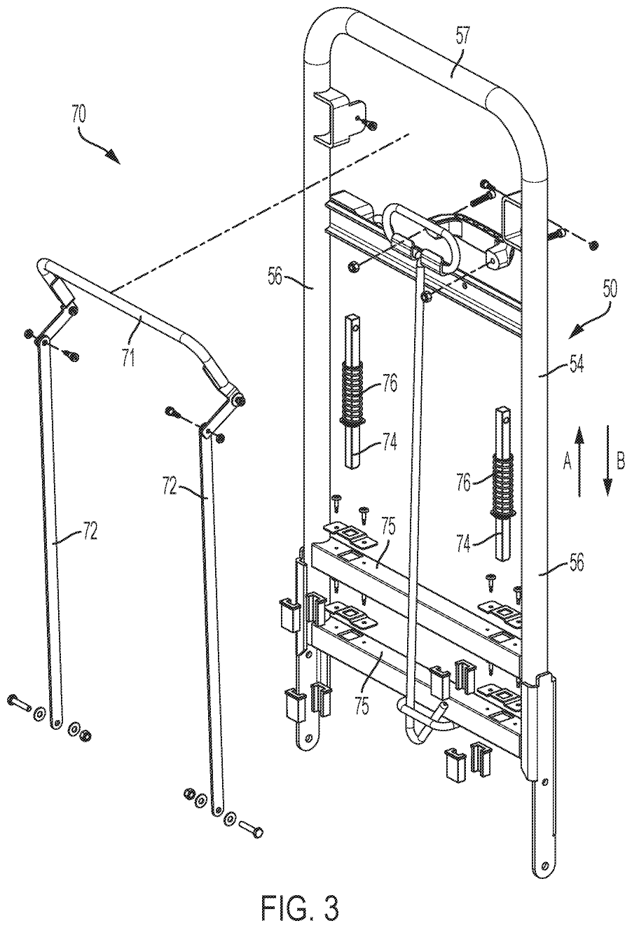

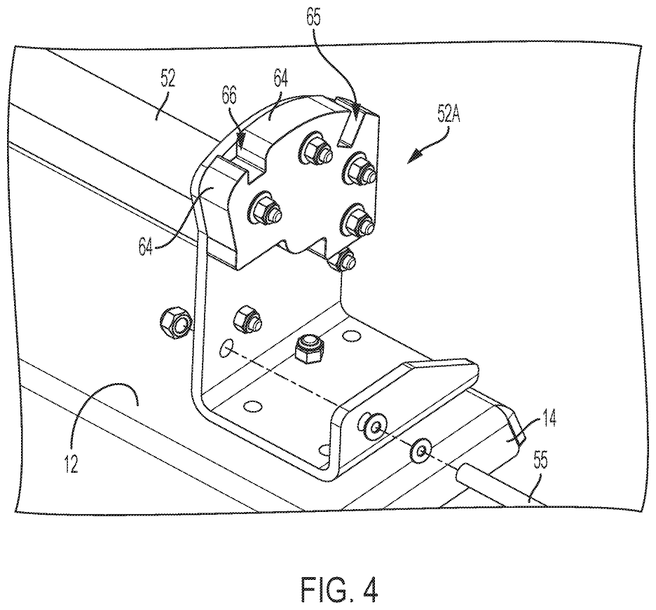

As shown in FIGS. 3 and 4, the handle apparatus 50 also has a latching device 70 for latching and retaining the handle 54 in different positions with respect to the base frame 12 and the lifting frame 22 (FIG. 2). The latching device 70 is located between the legs 56 of the handle 54. The latching device 70 includes a latch handle 71 pivotally connected to the legs 56 of the handle 54 and a pair of latch legs 72 that extend from the latch handle 71. Each latch leg 72 is coupled to a latch pin 74 which extends through a one or more latch crossbars 75 (see also FIG. 2). The latch crossbars 75 are spaced apart from each other and extend between the legs 56 of the handle 54. A latch spring 76 is located between the latch crossbars 75 (see FIG. 2) and along each of the latch pins 74. Each latch spring 76 has a natural resiliency that biases the latch pin 74 towards an extended position in which the latch pin 74 is received into one of the notches 65, 66 in the outer bearing surface 64 at the end 52A, 52B of the handle bracket 52 (FIG. 4).

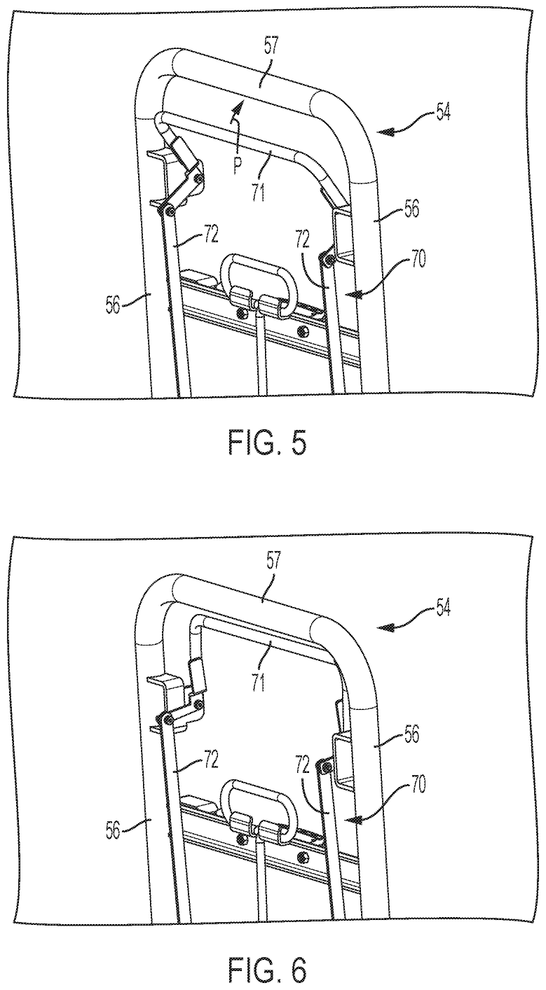

The handle 54 is manually pivotable about the first pivot axis 99 into and between the different positions shown in FIGS. 1, 7, and 8. In use, the operator manually engages and pulls (see arrow P on FIG. 5) the latch handle 71 from the position shown in FIG. 5 (e.g. inactive position) towards the position shown in FIG. 6 (e.g. active position). Pulling on the latch handle 71 pulls on the latch legs 72 and latch pins 74 (see arrow A in FIG. 3). This moves the latch pins 74 out of the notches 65 or 66 and compresses the latch springs 76 between the latch crossbars 75. Accordingly, the handle 54 can be manually pivoted about the first pivot axis 99 by the operator. When the latch handle 71 is thereafter released, the natural bias of the latch springs 76 moves the latch pins 74 back towards the outer bearing surface 64 (see arrow B on FIG. 3). As the handle 54 is manually pivoted about the first pivot axis 99, the latch pins 74 become aligned with one of the notches 65, 66 (FIG. 4). Once aligned, natural bias of the latch springs 76 forces the latch pins 74 into the next one of the notches 65, 66 and thereby latches the handle 54 in place with respect to the base frame 12 and lifting frame 22 (FIG. 2).

As is briefly mentioned above, the handle 54 can be pivoted into and between the folded position (FIG. 7), the intermediate position (FIG. 1), and the lifting position (FIG. 8). FIG. 7 depicts the handle 54 in the folded position in which the handle 54 is located between and/or on the lifting arms 24. The lifting frame 22 is in the lowered position. In this position, the cart 10 can be transported by an operator and/or stored. In certain examples, the cart 10 can include carry handles 80 configured for manual grasping by the operator. In certain examples, when the handle 54 is in the folded position the braces 58 extend parallel to and/or along the lifting arms 24. In certain examples, as the handle 54 is pivoted from the folded position toward the lifting position (FIG. 8) the handle bracket 52 (FIG. 4) cams the latch pin 74 away from the handle bracket 52 such that the latch spring 76 is compressed and the latch handle 71 pivots in a first direction relative to the handle 54 into the active position (see FIG. 6). When the latch pin 74 is aligned with the notch 66 the latch spring 76 moves the latch pin 74 into the notch 66 and the latch handle 71 pivots in a second direction opposite the first direction into the inactive position (see FIG. 5).

FIG. 1 depicts the handle 54 in the intermediate position in which the handle 54 extends generally perpendicularly with respect to the base frame 12. The intermediate position is between the folded position (FIG. 7) and the lifting position (FIG. 8). In the intermediate position, the cart 10 can be easily maneuvered by the operator so as to position the base frame 12 and the lifting frame 22 under a loaded pallet P (FIG. 9). The handle 54 is initially moved into the intermediate position by pivoting the handle 54 about the first pivot axis 99, as described hereinabove. As the handle 54 is pivoted towards the intermediate position, the latch pins 74 of the latching device 70 contact and slide along the outer bearing surface 64 of the ends 52A, 52B of the handle bracket 52 (see FIG. 2). Once the latch pins 74 are aligned with the second notches 66 (FIG. 2), the latch springs 76 move the latch pins 74 into the second notches 66 thereby retaining the handle 54 in the intermediate position. As the handle 54 is pivoted towards the intermediate position, the braces 58 slide along the pivot pins 29 connected to the lifting arms 24 (FIG. 2). That is, when the handle 54 is in the folded position (FIG. 7) each pivot pin 29 is near a second slot end 62 of the slot 59. When the handle 54 is in the intermediate position (FIG. 1) each pivot pin 29 is located at the first slot end 61 of the slot 59 (see also FIG. 10). In addition, the lifting frame 22 is in the lowered position when the handle 54 is in the intermediate position.

FIG. 8 depicts the handle 54 in the lifting position in which the handle 54 angularly and transversely extends from the base frame 12. To move the handle 54 from the intermediate position (FIG. 1) to the lifting position, the operator manually grasps and pulls the latch handle 71 (see arrow P on FIG. 5) until the latch pins 74 are retracted out of the second notches 66 (FIG. 2), as described hereinabove. The handle 54 is then manually pivoted (see arrow D in FIG. 1) such that the latch pins 74 slide along the outer bearing surface 64 toward the first notches 65 (FIGS. 2 and 4). As the handle 54 is pivoted toward the lifting position, the pivot pins 29 located in the slots 59 of the braces 58 (see above description) positively engage the first slot ends 61 (see FIG. 2) of the slot 59. The pulling force on the handle 54 creates a lever arm via the braces 58 and to the lifting arms 24 along the third pivot axis 101 (FIG. 1). This provides a mechanical advantage and allows the lifting arms 24 to be easily pivoted upwardly away from the base frame 12 and towards the handle 54, as facilitated by the link assemblies 36 (described hereinabove). The lifting frame 22 is moved into the raised position. The mechanical advantage permits lifting of pallets P (FIG. 9) having relatively heavy loads thereon. Once the latch pins 74 become aligned with the first notches 65 (FIGS. 2 and 4), the latch springs 76 bias the latch pins 74 into the first notches 65, thereby retaining the handle 54 in the lifting position shown in FIG. 8. As such, the pallet P is lifted off the ground as shown in FIG. 9. The handle 54 and the lifting frame 22 define an obtuse angle there between when the handle 54 is in the lifting position.

Once the operator has pushed the now-loaded cart 10 along the ground to the location where the pallet P (FIG. 9) will be set back onto the ground, the operator can manually pivot the handle 54 back to the intermediate position (FIG. 1) which lowers the pallet P onto the ground. To pivot the handle 54 from the lifting position (FIG. 8) to the intermediate position (FIG. 1; see also arrow E on FIG. 1), the operator manually grasps and pulls (see arrow P on FIG. 5) the latch handle 71 from the inactive position shown in FIG. 5 towards the active position shown in FIG. 6. This moves the latch pins 74 out of the first notches 65 (FIGS. 2 and 4) such that the handle 54 can be manually pivoted toward the intermediate position (FIG. 1). Once the latch pins 74 are aligned with the second notches 66 (FIGS. 2 and 4), the latch springs 76 cause the latch pins 74 to extend into the second notches 66 to thereby latch and retain the handle 54 in the intermediate position (FIG. 1). Accordingly, the lifting frame 22 lowers the pallet P onto the ground. Once the pallet P is on the ground, the cart 10 can be pulled out from under the pallet P.

FIG. 10 depicts the handle 54 in both the intermediate position (shown in solid lines in FIG. 10) and the angular, lifting position (shown in dashed lines in FIG. 10). FIG. 10 illustrates that when the handle 54 is in the intermediate position, the lifting frame 22 is located proximate to the base frame 12. The top of the lifting frame 22 is spaced from the top of the base frame 12 by a distance D1. Manually pivoting the handle 54 from the intermediate position to the lifting position (as described above) raises the lifting frame 22 such that that the top of the lifting frame 22 is spaced apart from the top of the base frame 12 by a greater second distance D2. As such, manual pivoting of the handle 54 from the intermediate position to the lifting position raises the pallet P (FIG. 9) upwardly off the ground. The distance the pallet P is lifted above the ground is the difference between the first distance D1 and the second distance D2. Specifically, as the handle 54 is pivoted the top of the lifting frame 22 and/or the longitudinal lifting surface 27 (FIG. 2) contacts the underside of the pallet P and lifts the pallet P off the ground. The side surfaces 28 (FIG. 2) may contact the side surfaces of the pallet P and prevent the pallet P from sliding off the lifting arms 24.

As shown in FIG. 10, the first end 67 of the brace 58 are coupled to the lifting arm 24 at a location closer to the first end 25 of the lifting arm 24 than the link assembly 36 (e.g. the pivot pin 29 is closer to the first end 25 of the lifting arm 24 than the link assembly 36, see distance D4). As such, the third pivot axis 101 is between the link assembly 36 and the first pivot axis 99 at all times as the handle 54 is pivoted. The spacing of the third pivot axis 101 relative to the first pivot axis 99 and the link assembly 36 achieves a mechanical advantage for pivoting the lifting frame 22 relative to the base frame 12 as the handle 54 is pivoted about the first pivot axis 99 when compared to conventional lifting carts. In addition, the second end 68 of the brace 58 is coupled to the leg 56 vertically above the first pivot axis 99. That is, the second pivot axis 100 is vertically offset from the first pivot axis 99 along the handle 54 and the second pivot axis 100 is spaced apart from the first pivot axis 99 by distance D3. Spacing the second pivot axis 100 apart from the first pivot axis 99 also achieves a mechanical advantage compared to conventional lifting carts. Accordingly, the orientation of the brace 58 relative to the pivot axes 99, 100, 101, the linking assembly 36, and/or the handle 54 enhances the lever arm (see arrow F in FIG. 10) applied by the brace 58 to the lifting arm 24 as the operator manually pivots the handle 54. In certain examples, reducing the distance between the first pivot axis 99 and the second pivot axis 100 (see arrow D3) decreases the amount of force applied by the lifting arm 24 as the handle 54 pivots. In certain examples, it is advantageous to offset the second pivot axis 100 from the first pivot axis 99 such that the handle 54 is in an ergonomic position (e.g. the intermediate position) for the operator to manually engage and pivot the handle 54.

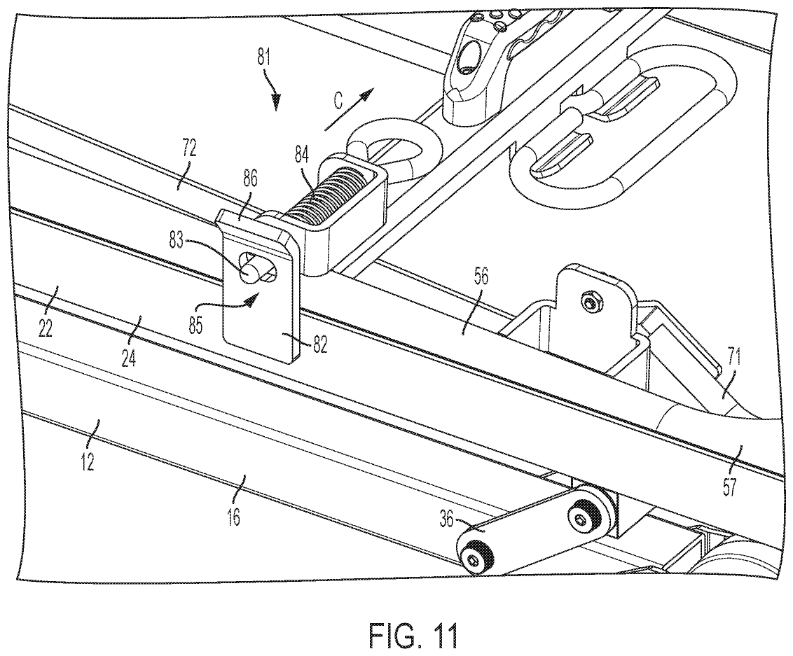

Referring to FIG. 11, a locking device 81 locks the handle 54 to the lifting arm 24 in the folded position (see FIG. 7). The locking device 81 has a locking bracket 82 on the lifting frame 22 and a locking pin 83 and a locking spring 84 on the handle 54. To unlock the handle 54 from the lifting arm 24 (see FIG. 7), the operator manually pulls the locking pin 83 away from the locking bracket 82 (see arrow C on FIG. 11), which compresses that the locking spring 84 and retracts the locking pin 83 from hole 85. This frees the handle 54 for pivoting from the folded position (FIG. 7) to the intermediate position (FIG. 1), as described above. To lock the handle 54 to the lifting arm 24, the operator manually pivots the handle 54 towards the folded position (FIG. 7) such that the locking pin 83 engages and is cammed by a sloped surface 86 on the locking bracket 82 (see arrow C on FIG. 11). Continued pivoting of the handle 54 toward the folded position (FIG. 7) causes the locking pin 83 to align with the hole 85. As such, the locking spring 84 biases the locking pin 83 into the hole 85 thereby locking the handle 54 to the locking bracket 82.

In the present description, certain terms have been used for brevity, clarity, and understanding. No unnecessary limitations are to be inferred therefrom beyond the requirement of the prior art because such terms are used for descriptive purposes only and are intended to be broadly construed. The different apparatuses described herein may be used alone or in combination with other apparatuses. Various equivalents, alternatives, and modifications are possible within the scope of the appended claim

1.-13. (canceled)

14. The cart according to claim 15, further comprising a latch handle coupled to the latch pin and pivotably coupled to the handle, and wherein the latch handle is pivotable relative to the handle to thereby move the latch pin out of notch such that the handle can freely pivot.

15. A cart for lifting a load, the cart comprising:
a base frame;
a handle bracket on the base frame and defining a notch;
a lifting frame pivotally coupled to the base frame;
a handle pivotally coupled to the handle bracket; and
a brace having a first end pivotally coupled to the handle and an opposite second end pivotally coupled to the lifting frame;
wherein the handle is pivotable into and between a folded position in which the handle is folded onto the lifting frame and a lifting position in which the handle is transverse to the base frame and the lifting frame is pivoted away from the base frame;
wherein when the handle is in the lifting position a latch pin is received into the notch of the handle bracket to thereby lock the handle in the lifting position; and
wherein as the handle is pivoted from the folded position toward the lifting position the latch pin slides along the handle bracket until the latch pin is aligned with the notch and is thereby received therein.

16. The cart according to claim 15, further comprising a spring that biases the latch pin into the notch when the latch pin is aligned with the notch.

17. The cart according to claim 16, further comprising a latch handle coupled to the latch pin and pivotably coupled to the handle, and wherein the latch handle is pivotable relative to the handle to thereby compress the spring and move the latch pin out of the notch such that the handle can freely pivot.

18. The cart according to claim 16, wherein as the handle is pivoted from the folded position toward the lifting position the handle bracket cams the latch pin away from the handle bracket such that the spring is compressed and the latch handle pivots in a first direction relative to the handle, and wherein when the latch pin is aligned with the notch the spring moves the latch pin into the notch and the latch handle pivots in a second direction opposite the first direction.

19. A cart for lifting a load, the cart comprising:
a base frame;
a handle bracket on the base frame and defining a notch;
a lifting frame pivotally coupled to the base frame;
a handle pivotally coupled to the handle bracket; and
a brace having a first end pivotally coupled to the handle and an opposite second end pivotally coupled to the lifting frame;
wherein the handle is pivotable into and between a folded position in which the handle is folded onto the lifting frame and a lifting position in which the handle is transverse to the base frame and the lifting frame is pivoted away from the base frame;
wherein when the handle is in the lifting position a latch pin is received into the notch of the handle bracket to thereby lock the handle in the lifting position;
wherein the notch is a first notch and wherein the handle bracket has a second notch spaced apart from the first notch;
wherein the handle is pivotable into an intermediate position between the folded position and the lifting position; and
wherein when the handle is in the intermediate position the latch pin is received into the second notch to thereby lock the handle in the intermediate position and prevent further pivoting of the handle.

20. The cart according to claim 19, further comprising a latch handle coupled to the latch pin and pivotably coupled to the handle, and wherein the latching handle is pivotable relative to the handle to thereby move the latch pin out of the first notch or the second notch such that the handle can freely pivot.

21. A cart for lifting a load, the cart comprising:
a base frame;
a lifting frame coupled to the base frame and being moveable into and between a raised position in which the lifting frame is raised with respect to the base frame and a lowered position in which the lifting frame is lowered with respect to the base frame;
a handle pivotably coupled to the base frame; and
a brace extending between the handle and the lifting frame, wherein the brace is coupled to the handle by a first one of a fixed pivot joint and a movable pivot joint and to the lifting frame by a second one of the fixed pivot joint and movable pivot joint;
wherein pivoting of the handle away from the lifting frame raises the lifting frame to the raised position and thereby lifts the load, and wherein pivoting of the handle back towards the lifting frame lowers the lifting frame to the lowered position and thereby lowers the load; and
wherein once the lifting frame is in the lowered position, the movable pivot joint facilitates further pivoting of the handle towards the frame into a storage position.

22. The cart according to claim 21, wherein the movable pivot joint comprises a slot and a pin that slides along the slot, wherein pivoting of the handle away from the lifting frame causes the pin to slide into engagement with an end of the slot such that further pivoting of the handle away from the lifting frame raises the lifting frame to the raised position and thereby lifts the load, and wherein pivoting of the handle back towards the lifting frame lowers the lifting frame to the lowered position and thereby lowers the load, and whereupon further pivoting of the handle towards the frame into a storage position is facilitated by sliding of the pin back away from the end of the slot.

23. The cart according to claim 21, wherein in the storage position the handle is in a parallel alignment with the base frame.

24. The cart according to claim 21, wherein the handle is pivotable with respect to the base frame along a first pivot axis, and wherein the brace is pivotable with respect to the handle along a second pivot axis that is spaced apart from the first pivot axis.

25. The cart assembly according to claim 24, wherein the brace is coupled to the handle by the fixed pivot joint along the second pivot axis and to the lifting frame by the movable pivot joint along a third pivot axis.

26. The cart according to claim 25, further comprising a plurality of link assemblies that pivotably couple the lifting frame to the base frame so that as the handle is pivoted relative to the base frame, the lifting frame is pivoted relative to the base frame.

27. The cart according to claim 26, wherein each link assembly in the plurality of link assemblies comprises a pair of link arms that are pivotably coupled to the base frame and lifting frame.

28. The cart according to claim 26, wherein the third pivot axis is located closer to the first pivot axis than the plurality of link assemblies.

29. The cart according to claim 21, further comprising a latching device configured to latch the handle in a plurality of positions with respect to the base frame, wherein the latching device comprises a latch handle configured to disengage a latch pin from a handle bracket on the base frame so as to permit pivoting of the handle with respect to the base frame.

30. The cart according to claim 29, wherein the latch pin is biased into engagement with the handle bracket by a spring.

31. The cart according to claim 30, wherein the handle bracket comprises a plurality of notches that receive the latch pin to thereby lock the handle in a corresponding plurality of positions with respect to the base frame.

32. The cart according to claim 31, wherein the plurality of positions comprises a stored position in which the lifting frame is in the lowered position and the handle extends generally parallel to the base frame, a lifting position in which the lifting frame is in the raised position, and an intermediate position between the stored position and lifting position and in which the lifting frame is in the lowered position and the handle extends generally perpendicularly to the base frame.

33. The cart according to claim 32, wherein pivoting of the handle with respect to the base frame moves the latch pin along the handle bracket until the spring forces the latch pin into one of the plurality of notches.

34. A cart for lifting a load, the cart comprising:
a base frame;
a lifting frame coupled to the base frame and being moveable into and between a raised position in which the lifting frame is raised with respect to the base frame and a lowered position in which the lifting frame is lowered with respect to the base frame;
a handle pivotably coupled to the base frame; and
a brace extending between the handle and the lifting frame, wherein the brace is coupled to the handle by a first one of a fixed pivot joint and a movable pivot joint and to the lifting frame by a second one of the fixed pivot joint and movable pivot joint;
wherein the movable pivot joint comprises a slot and a pin that slides along the slot, wherein pivoting of the handle away from the lifting frame causes the pin to slide into engagement with an end of the slot such that further pivoting of the handle away from the lifting frame raises the lifting frame to the raised position and thereby lifts the load, and wherein pivoting of the handle back towards the lifting frame lowers the lifting frame to the lowered position and thereby lowers the load, and whereupon further pivoting of the handle towards the frame into a storage position is facilitated by sliding of the pin back away from the end of the slot.
